(19) United States
(12) Patent Application Publication
(10) Pub. No.: US 2013/0344359 A1
(43) Pub. Date: Dec. 26, 2013

(54) MODULAR ENERGY STORAGE SYSTEM

(71) Applicant: EnerDel, Inc., Greenfield, IN (US)

(72) Inventors: Kelly Ledbetter, Carmel, IN (US); Robert N. Fattig, Anderson, IN (US); Bruce Hamilton, Noblesville, IN (US); Mark Lavin, Fishers, IN (US); Karl Hopper, Alexandria, IN (US)

(21) Appl. No.: 13/927,775

(22) Filed: Jun. 26, 2013

Related U.S. Application Data
(60) Provisional application No. 61/781,507, filed on Mar. 14, 2013.
(60) Provisional application No. 61/664,446, filed on Jun. 26, 2012.

(51) Int. Cl. H01M 10/50; H01M 2/20

(52) U.S. Cl. CPC H01M 10/5057; H01M 2/206; H01M 2/204
USPC 429/83; 429/99; 429/100

(57) ABSTRACT

An exemplary modular energy storage system is disclosed. The modular energy storage system may include an enclosure, a plurality of battery modules positioned within the enclosure and operatively connected to a high voltage connector accessible from an exterior of the enclosure; a battery management system positioned within the enclosure, the battery management system including at least one contactor; and an air plenum positioned within the enclosure. Air may enter at least one inlet in the enclosure, passes through the air plenum, across a plurality of heat sink fins associated with the plurality of battery modules, and exit through at least one outlet in the enclosure. The at least one contactor may positioned within the enclosure to a first side of the plurality of battery modules and above the at least one inlet. An exemplary endplate for a battery module having a plurality of battery cells is also disclosed. The endplate may comprise a power bus terminal having a first connector and a second connector; and a body supporting the power bus terminal. The power bus terminal may be positioned between an internal face of the body and an external face of the body and the first connector and the second connector extend outside of the body.

### RELATED APPLICATIONS

This application claims the benefit of U.S. Provisional Application Ser. No. 61/664,446, filed Jun. 26, 2012, titled MODULAR ENERGY SYSTEM FOR A TROLLEYBUS, docket ENERD-P12-003-01-US, and U.S. Provisional Application Ser. No. 61/781,507, filed Mar. 14, 2013, titled MODULAR ENERGY SYSTEM FOR A TROLLEYBUS, docket ENERD-P12-003-02-US-E, the disclosures of which are expressly incorporated by reference herein.

### FIELD

The present invention is directed to energy storage systems and methods and more particularly to battery energy storage systems and methods.

### BACKGROUND

Energy storage systems including battery storage systems are known. Further, it is known to monitor and control a temperature of a battery cell in a battery storage system.

### SUMMARY

In an exemplary embodiment of the present disclosure, a battery module is provided. The battery module comprising a plurality of battery assemblies removably coupled together, each battery assembly including a plurality of battery cells and a plurality of frames to hold the plurality of battery cells; a first endplate removably coupled to the plurality of battery assemblies, the first power bus terminal is electrically connected to the battery cells of the battery assemblies; and a second endplate removably coupled to the plurality of battery assemblies. The first endplate including a body and a first power bus terminal. The second endplate having a second power bus terminal that is electrically connected to the battery cells. The plurality of battery assemblies being positioned between the first endplate and the second endplate. The first power bus terminal is supported by the first endplate. The first power bus terminal is positioned between an internal face of the first endplate and an external face of the first endplate.

In one example thereof, the first endplate power bus terminal includes a first connector and a second connector, each of the first connector and the second connector extend outside of the body of the first endplate. In a variation thereof, the first connector extends from a first side of the first endplate and the second connector extends from a second side of the first endplate. In another variation thereof, the first side of the first endplate is a top side of the first endplate. In still another variation thereof, the second side of the first endplate is adjacent to the first side of the first endplate. In yet another variation thereof, the first connector extends in a first direction over towards the second endplate. In a refinement thereof, the second connector extends in the first direction. In a further variation thereof, the body is made of a moldable material and the first power bus terminal is overmolded by the body.

In another exemplary embodiment of the present disclosure, an endplate for battery module having a plurality of battery cells is provided. The endplate comprising a power bus terminal having a first connector and a second connector; and a body supporting the power bus terminal. The power bus terminal is positioned between an internal face of the body and an external face of the body and the first connector and the second connector extend outside of the body.

In an example thereof, the body is made of a moldable material and the power bus terminal is overmolded by the body.

In another example thereof, the first connector extends from a side of the body and is adapted to be electrically coupled to the battery cells of the battery module.

In still another example thereof, the first connector extends from a first side of the first endplate and the second connector extends from a second side of the first endplate. In a variation thereof, the first side of the first endplate is a top side of the first endplate. In another variation thereof, the second side of the first endplate is adjacent to the first side of the first endplate. In still another variation thereof, the first connector extends in a first direction over towards the second endplate. In a refinement thereof, the second connector extends in the first direction.

In a further exemplary embodiment of the present disclosure, a modular energy storage system is provided. The modular energy storage system comprising an enclosure, a plurality of battery modules positioned within the enclosure and operatively connected to a high voltage connector accessible from an exterior of the enclosure; a battery management system positioned within the enclosure, the battery management system including at least one contactor; and an air plenum positioned within the enclosure. Air enters at least one inlet in the enclosure, passes through the air plenum, across a plurality of heat sink fins associated with the plurality of battery modules, and exits through at least one outlet in the enclosure. The at least one contactor is positioned within the enclosure to a first side of the plurality of battery modules and above the at least one inlet.

In an example thereof, the modular energy storage system further comprises a heating system positioned within the enclosure, the heating system being spaced apart from the air plenum. In a variation thereof, the heating system is positioned within the enclosure below the plurality of battery modules. In a refinement thereof, the heating system is accessible through a bottom cover of the enclosure and the at least one contactor is accessible through a top cover of the enclosure. In another variation thereof, the heating system is a resistive electric system.

The above and other features of the present disclosure, which alone or in any combination may comprise patentable subject matter, will become apparent from the following description and the attached drawings.

### BRIEF DESCRIPTION OF THE DRAWINGS

FIG. 1 illustrates a front isometric view of an exemplary modular energy storage system;

FIG. 2 illustrates a rear isometric view of the modular energy storage system of FIG. 1;

FIG. 3 illustrates the modular energy storage system of FIG. 1 with a top cover removed;

FIG. 4 illustrates a front isometric view of another exemplary modular energy storage system with a top cover removed.

FIG. 5 illustrates an exemplary battery sub-pack assembly of the modular energy storage system of FIG. 1;

FIG. 6 illustrates an exemplary battery module modular energy storage system of FIG. 1;

FIG. 7 illustrates an exemplary endplate of the battery module of FIG. 6 illustrating an exterior view of the endplate;

FIG. 8 illustrates the exemplary endplate of FIG. 8 illustrating an interior view of the endplate; and

FIG. 9 illustrates a partial view of a cooling system of an exemplary modular energy storage system.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION OF THE DRAWINGS

The embodiments disclosed herein are not intended to be exhaustive or limit the invention to the precise form disclosed in the following detailed description. Rather, the embodiment is chosen and described so that others skilled in the art may utilize its teachings.

An exemplary application for the energy storage systems described herein is a trolleybus. A trolleybus is used to transport cargo and/or people from place to place. Exemplary trolleybuses receive power from an overhead electrical caternary or other power source to power a propulsion system of the trolleybus. Exemplary propulsion systems include electric motors, internal combustion engines, and other suitable systems to propel the trolleybus. In one embodiment, a modular energy storage system for a trolleybus is provided. The modular energy storage system may provide power to the propulsion system of the trolleybus. Exemplary modular energy storage systems are disclosed herein. The exemplary modular energy storage systems may provide power to the propulsion system of the trolleybus when the trolleybus is disconnected from the overhead electrical catenary.

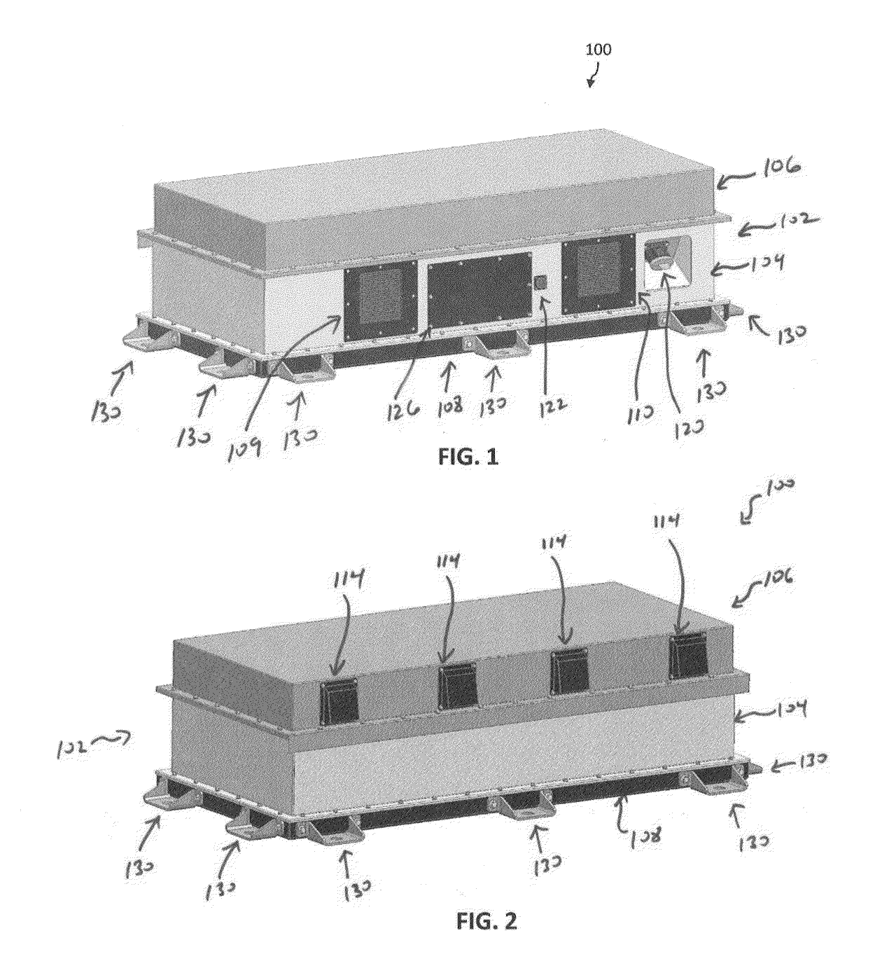

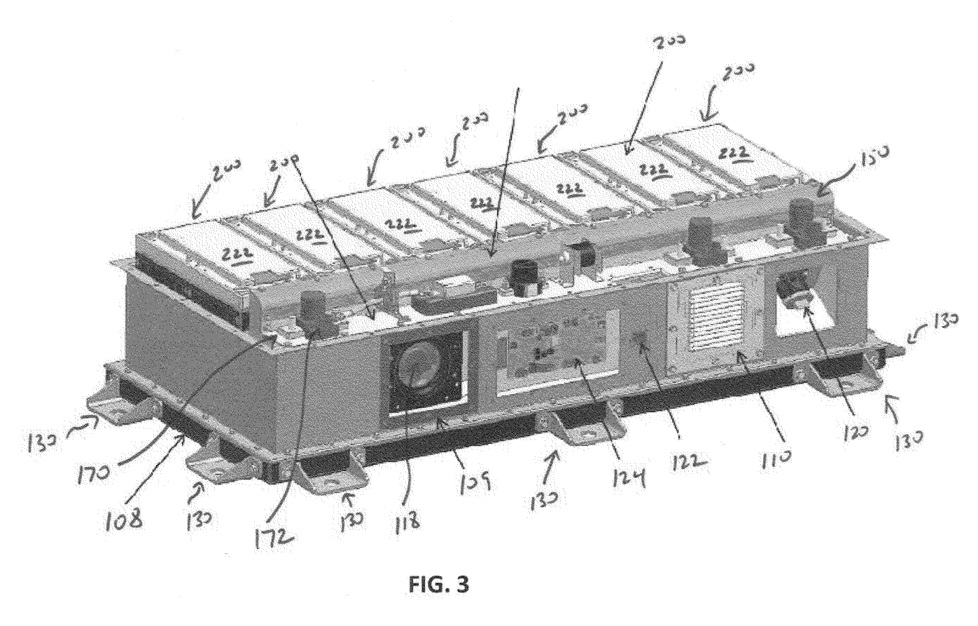

Referring to FIG. 1, an exemplary modular energy storage system 100 is shown. Modular energy storage system 100 includes an enclosure 102 having a body 104, a top cover 106 removably coupled to body 104 and a bottom cover 108 removably coupled to the body 104. Enclosure 102 provides a first air inlet 109 and a second air inlet 110 through which air is received into the enclosure 102 to lower a temperature associated with a plurality of batteries positioned within enclosure 102. In the illustrated embodiment, air is pulled into enclosure 102 with a fan unit 118 (see FIG. 3). The air is exhausted from enclosure 102 through outlets 114 (see FIG. 2) provided in top cover 106 of modular energy storage system 100.

Enclosure 102 further provides a high voltage connector 120 which is accessible from an exterior of the enclosure 102. The high voltage connector 120 is operatively coupled to the plurality of batteries positioned within the enclosure. A low voltage connector 122 is also accessible from an exterior of the enclosure 102. A master controller 124 (see FIG. 3) is accessible by removing a cover 126 from enclosure 102.

A plurality of mounting feet 130 are provided on enclosure 102. Mounting feet 130 permit the mounting of modular energy storage system 100 in various locations. For example, in the case of a trolley bus, modular energy storage system 100 may be mounted on the roof of the trolley bus or the cabin of the trolleybus.

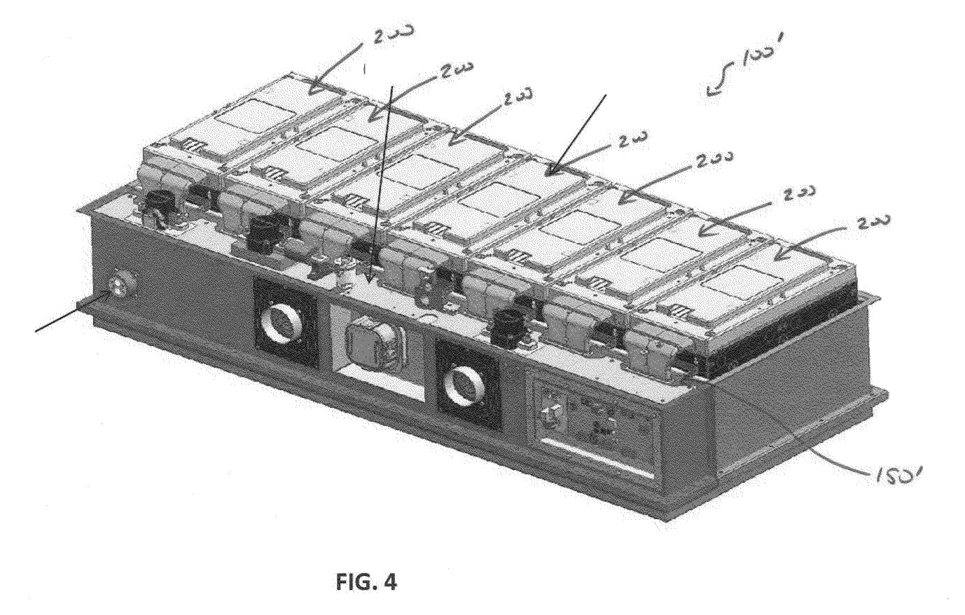

Referring to FIG. 3, cover 106 has been removed from body 104. As illustrated in FIG. 3, a plurality of battery sub-packs 200 is illustrated. Further, an air plenum 150 is illustrated. As explained in more detail herein, air enters bottom first air inlet 109 and second air inlet 110, passes through air plenum 150, passes through battery sub-packs 200 (under a cover 222 of sub-pack 200), and exits from outlets 114 of energy storage system 100. The air plenum 150 illustrated in FIG. 3 extends across a plurality of sub-packs 200. The air plenum 150′ illustrated in FIG. 4 includes feeder plenums that correspond to respective sub-packs 200.

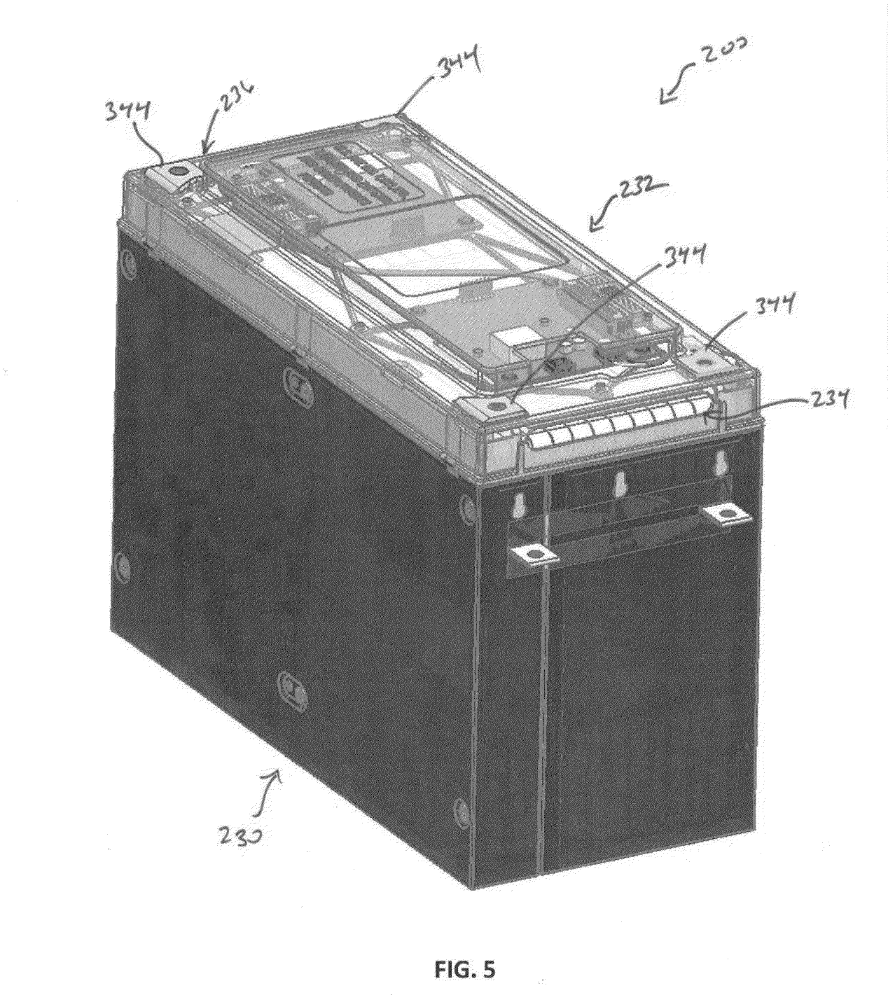

Referring to FIG. 5, an exemplary battery sub-packs 200 is shown. Battery sub-pack 200 includes a body 230 and a cover 232. The body 230 may be a low carbon steel case for structural protection of sub-packs. The cover 232 may be an electrical insulating polymer cover for the battery modules and remote controllers of the battery management system.

Cover 232 includes an opening 234 through which air enters an interior of battery sub-pack 200 and an opening 236 through which air is exhausted from the interior battery sub-pack 200. Battery sub-pack 200 includes a plurality of battery modules 300.

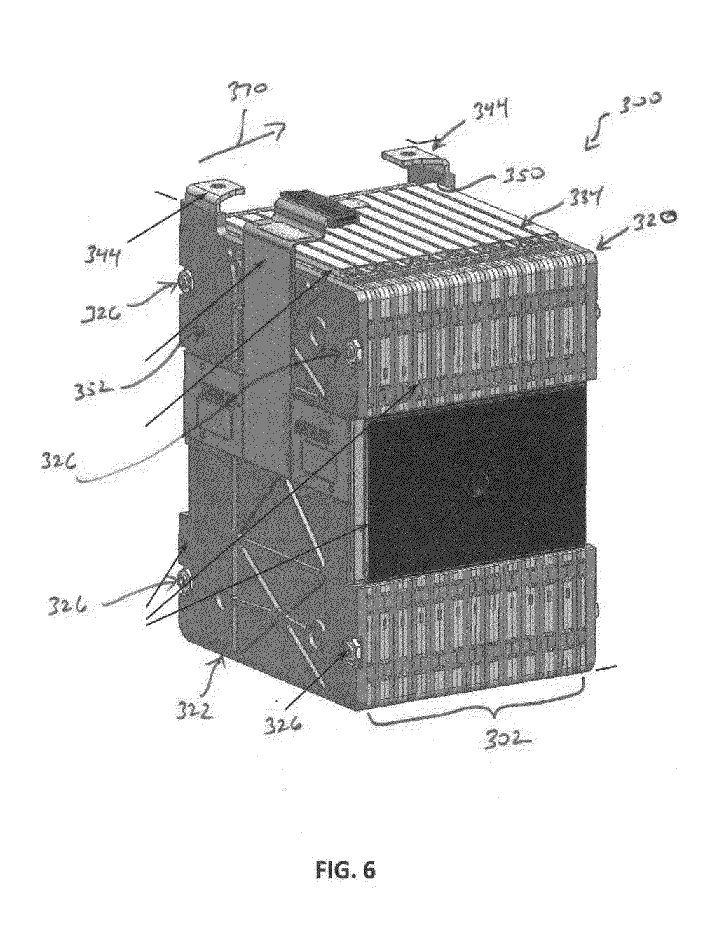

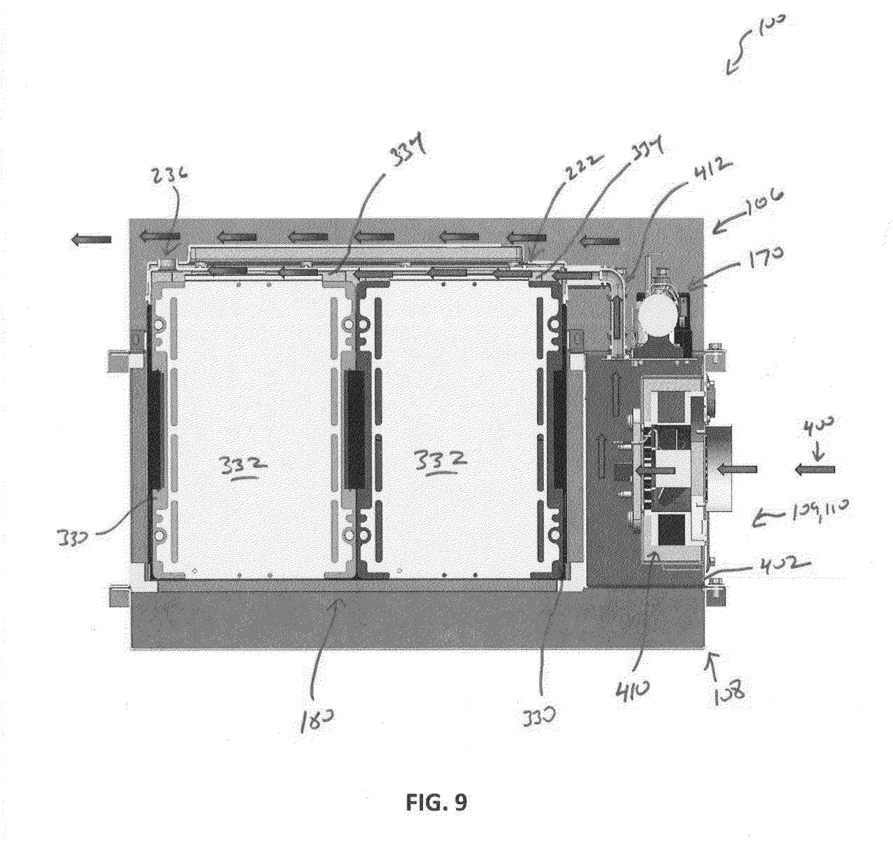

An exemplary battery module 300 is illustrated in FIG. 6. Battery module 300 includes a plurality of elements 302. Each element includes a plurality of battery cells. Each element 302 includes a plurality of frames 330 which support the cells and a heat transfer member 332 (see FIG. 9). The heat transfer member 332 includes an upper fin 334 which is exposed to the air passing through the modular energy storage system 100. In the illustrated embodiment, battery module 300 includes twelve elements 302 and each element 302 includes two battery cells.

Battery module 300 further includes a first endplate 320 and a second endplate 322. The first endplate 320, the plurality of elements 302, and second endplate 322 are retained together with a plurality of tie rods 326.

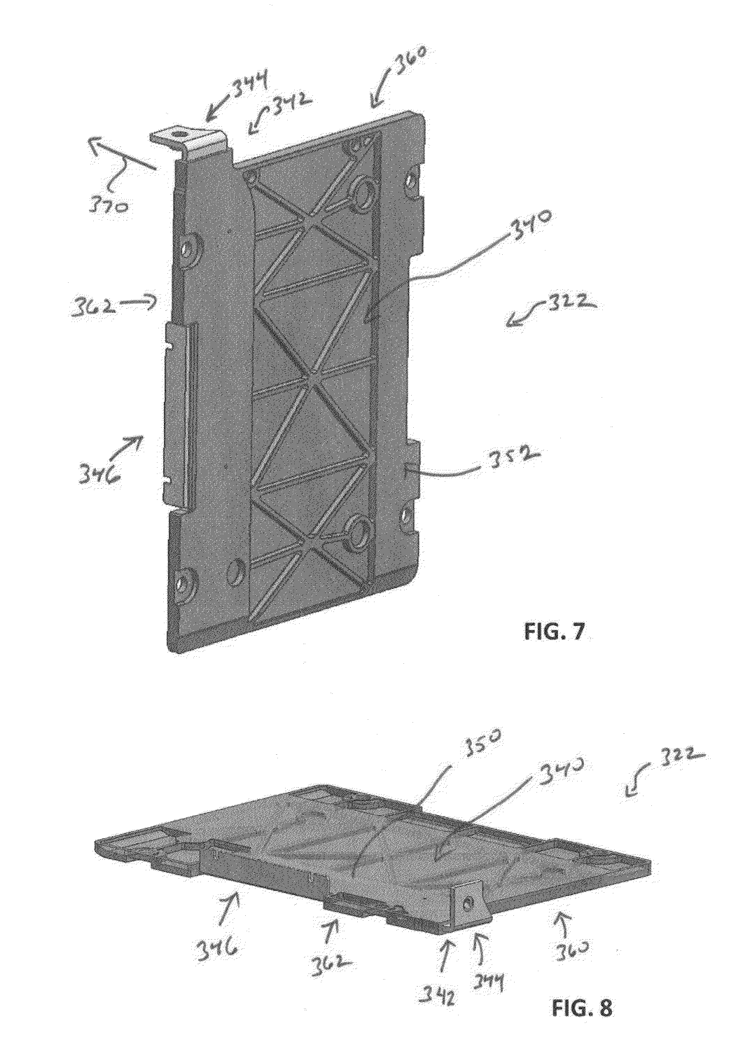

Referring to FIGS. 7 and 8, second endplate 322 is shown. Second endplate 322 includes a body 340 and a power bus terminal 342. Power bus terminal 342 includes a first connector 344 and a second connector 346. Power bus terminal 342 is supported by body 340. Except for first connector 344 and second connector 346, power bus terminal 342 is positioned between an internal face 350 of second endplate 322 and an external face 352 of second endplate 322. In the illustrated embodiment, body 340 is made of a moldable material and power bus terminal 342 is overmolded by body 340.

Each of the first connector 344 and the second connector 346 extend outside of the body 340 of the endplate 322. The first connector 344 extends from a first side 360 of second endplate 322 and the second connector 346 extends from a second side 362 of second endplate 322. In the illustrated embodiment, first side 360 of second endplate 322 is a top side of second endplate 322. In the illustrated embodiment, second side 362 is adjacent to first side 360.

Referring to FIG. 6, first connector 344 of power bus terminal 342 of second endplate 322 extends in a first direction 370 towards first endplate 320. Referring back to FIG. 7, both first connector 344 and second connector 346 of power bus terminal 342 extend in first direction 370.

Referring to FIG. 9, an exemplary air flow through modular energy storage system 100 is illustrated. Air 400 enters through a front face 402 of modular energy storage system 100. In the illustrated embodiment, air 400 is pulled by a fan unit 410 into an interior of modular energy storage system 100. The air is then communicated through an air plenum 412 into an interior of battery sub-packs 200 where the air 400 passes by upper fin 334 of member 332 of battery modules 300.

Referring to FIG. 9, a battery management system 170 is shown. Battery management system 170 includes at least one contactor 172. In one embodiment, the battery management system 170 includes primary contactors, secondary contactors, a current sensor assembly, fuse, and master controller. As illustrated in FIG. 3, contactor 172 is positioned within the enclosure 102 to a first side of the plurality of battery modules 300 located in battery sub-packs 200 and above the at least one air inlet 108, 110. Returning to FIG. 9, modular energy storage system 100 further includes a heating system 180. Heating system 180 is spaced apart from air plenum 412. Further, heating system 180 is positioned within the enclosure 102 below the plurality of battery modules 300. The heating system may be a resistive element heating system.

In one embodiment, battery management system 170 includes controls for pre-charge of the system, a closing sequence of the contactors, and an opening sequence of the contactors. The battery management system 170 monitors temperature, state of charge, voltage, and state of health.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A battery module, comprising:
a plurality of battery assemblies removably coupled together, each battery assembly including a plurality of battery cells and a plurality of frames to hold the plurality of battery cells;
a first endplate removably coupled to the plurality of battery assemblies, the first endplate including a body and a first power bus terminal, the first power bus terminal is electrically connected to the battery cells of the battery assemblies; and
a second endplate removably coupled to the plurality of battery assemblies, the second endplate having a second power bus terminal that is electrically connected to the battery cells,
wherein the plurality of battery assemblies being positioned between the first endplate and the second endplate and the first power bus terminal is supported by the first endplate and the first power bus terminal is positioned between an internal face of the first endplate and an external face of the first endplate.

2. The battery module of claim 1, wherein the first endplate power bus terminal includes a first connector and a second connector, each of the first connector and the second connector extend outside of the body of the first endplate.

3. The battery module of claim 2, wherein the first connector extends from a first side of the first endplate and the second connector extends from a second side of the first endplate.

4. The battery module of claim 3, wherein the first side of the first endplate is a top side of the first endplate.

5. The battery module of claim 3, wherein the second side of the first endplate is adjacent to the first side of the first endplate.

6. The battery module of claim 3, wherein the first connector extends in a first direction towards the second endplate.

7. The battery module of claim 6, wherein the second connector extends in the first direction.

8. The battery module of claim 3, wherein the body is made of a moldable material and the first power bus terminal is overmolded by the body.

9. An endplate for a battery module having a plurality of battery cells, the endplate comprising:
a power bus terminal having a first connector and a second connector; and
a body supporting the power bus terminal, wherein the power bus terminal is positioned between an internal face of the body and an external face of the body and the first connector and the second connector extend outside of the body.

10. The endplate of claim 9, wherein the body is made of a moldable material and the power bus terminal is overmolded by the body.

11. The endplate of claim 9, wherein the first connector extends from a side of the body and is adapted to be electrically coupled to the battery cells of the battery module.

12. The battery module of claim 9, wherein the first connector extends from a first side of the first endplate and the second connector extends from a second side of the first endplate.

13. The battery module of claim 12, wherein the first side of the first endplate is a top side of the first endplate.

14. The battery module of claim 12, wherein the second side of the first endplate is adjacent to the first side of the first endplate.

15. The battery module of claim 12, wherein the first connector extends in a first direction towards the second endplate.

16. The battery module of claim 15, wherein the second connector extends in the first direction.

17. A modular energy storage system, comprising:
an enclosure,
a plurality of battery modules positioned within the enclosure and operatively connected to a high voltage connector accessible from an exterior of the enclosure;
a battery management system positioned within the enclosure, the battery management system including at least one contactor; and
an air plenum positioned within the enclosure, air enters at least one inlet in the enclosure, passes through the air plenum, across a plurality of heat sink fins associated with the plurality of battery modules, and exits through at least one outlet in the enclosure, wherein the at least one contactor is positioned within the enclosure to a first side of the plurality of battery modules and above the at least one inlet.

18. The modular energy storage system of claim 17, further comprising a heating system positioned within the enclosure, the heating system being spaced apart from the air plenum.

19. The modular energy storage system of claim 18, wherein the heating system is positioned within the enclosure below the plurality of battery modules.

20. The modular energy storage system of claim 19, wherein the heating system is accessible through a bottom cover of the enclosure and the at least one contactor is accessible through a top cover of the enclosure.

21. The modular energy storage system of claim 18, wherein the heating system is a resistive electric system.
